(19) United States
(12) Patent Application Publication
(10) Pub. No.: US 2026/0229799 A1
(43) Pub. Date: Aug. 6, 2026

(54) Electrical Wire Connector and Methods of Use

(71) Applicant: J Moss, Roswell, GA (US)

(72) Inventor: J Moss, Roswell, GA (US)

(21) Appl. No.: 19/043,143

(22) Filed: Jan. 31, 2025

(51) Int. Cl. H01R 9/24; H01R 4/48; H01R 4/50

(52) U.S. Cl. CPC H01R 9/2416; H01R 4/48185; H01R 4/483; H01R 4/485; H01R 4/5008

(57) ABSTRACT

An electrical wire connector and methods of use to provide an apparatus for multi-wire connector having one or more connector modules position side-by-side, each module having a stacked first wire gripper positioned in a casing, as an upper levered latch having a cam rotationally connected with the first wire gripper, and rotatable between a wire release position and a wire grip position, a second wire gripper positioned in the casing below said first wire gripper, a lower levered latch having a cam rotationally connected with the second wire gripper, and rotatable between a wire release position and a wire grip position, and a U-shaped conduit positioned between the first wire gripper and the second wire gripper to make an electrical connection therebetween.

### FIELD OF THE DISCLOSURE

The present disclosure is directed to electrical wire connectors. More specifically, the present disclosure is directed to an apparatus to splice or join one or more wire ends to make an electrical connection.

### BACKGROUND

Wire splicers and wire connectors of a different configuration exist, such as push-in, wire nuts, crimp connectors, lever connectors.

A disadvantage with conventional wire splicers and wire connectors is the added length of the connector having both spliced wires connected in a linear single plane.

Therefore, it is readily apparent that there is a recognizable unmet need for an electrical wire connector and methods of use that may be configured to address at least some aspects of the problems discussed above.

### SUMMARY

Briefly described, in an example embodiment, the present disclosure may overcome the above-mentioned disadvantages and may meet the recognized need for an electrical wire connector and methods of use to provide an apparatus for multi-wire connector having one or more connector modules position side-by-side, each module having a first wire gripper positioned in a casing, an upper levered latch having a cam rotationally connected with the first wire gripper, and rotatable between a wire release position and a wire grip position, a second wire gripper positioned in the casing below said first wire gripper, a lower levered latch having a cam rotationally connected with the second wire gripper, and rotatable between a wire release position and a wire grip position, and a U-shaped conduit positioned between the first wire gripper and the second wire gripper to make an electrical connection therebetween.

Accordingly, in one aspect, the present disclosure may enable electrical connection of a first ROMEX set of three wires, including hot, common, and ground to another second ROMEX set of three wires, including hot, common, and ground, respectively using a three way connector.

Accordingly, in another aspect, the present disclosure may enable electrical connection of a ROMEX set of three wires, including hot, common, and ground to another set of three wires, including hot, common, and ground, respectively using a three way connector.

Accordingly, in another aspect, the present disclosure may enable electrical connection of a set of three wires, including hot, common, and ground to another set of three wires, including hot, common, and ground, respectively using a three way connector.

Accordingly, in another aspect, the present disclosure may enable electrical connection of one or more wires to another set of one or more wires, respectively using a similar number way connector.

Accordingly, in another aspect, the present disclosure may enable electrical connection of a one wire to another set of one or more wires, respectively using a one upper connector and a similar lower number way connector connected via a common U-shaped conduit between stacked connectors.

In an exemplary embodiment of a multi-wire connector apparatus to electrically connect a plurality of wire ends to another plurality of wire ends, the apparatus having one or more stacked connector modules position side-by-side, each module having an upper lever having a cam connected thereto and rotationally operable with an upper wire gripper, the upper wire gripper rotatable between a wire release position and a wire grip position, a lower lever having a cam connected thereto and rotationally operable with a lower wire gripper, the lower wire gripper rotatable between a wire release position and a wire grip position, and a conductor positioned between the upper wire gripper and the lower wire gripper to make an electrical connection therebetween.

In a second exemplary embodiment of a multi-wire splitter apparatus to electrically connect one wire end to another two wire ends, the apparatus having one stacked connector module, having a first upper lever having a cam connected thereto and rotationally operable with a first upper wire gripper, the first upper wire gripper rotatable between a wire release position and a wire grip position, a lower lever having a cam connected thereto and rotationally operable with a lower wire gripper, the lower wire gripper rotatable between a wire release position and a wire grip position, a second upper lever having a cam connected thereto and rotationally operable with a second upper wire gripper, the second upper wire gripper rotatable between a wire release position and a wire grip position, and a conductor positioned between the first upper wire gripper, the second upper wire gripper, and the lower wire gripper to make an electrical connection therebetween.

In a third exemplary embodiment of a multi-wire splitter apparatus to electrically connect one wire end to another three wire ends, the apparatus having one stacked connector module, having a first upper lever having a cam connected thereto and rotationally operable with a first upper wire gripper, the first upper wire gripper rotatable between a wire release position and a wire grip position, a lower lever having a cam connected thereto and rotationally operable with a lower wire gripper, the lower wire gripper rotatable between a wire release position and a wire grip position, a second upper lever having a cam connected thereto and rotationally operable with a second upper wire gripper, the second upper wire gripper rotatable between a wire release position and a wire grip position, a third upper lever having a cam connected thereto and rotationally operable with a third upper wire gripper, the third upper wire gripper rotatable between a wire release position and a wire grip position, and a conductor positioned between the first upper wire gripper, the second upper wire gripper, the third upper wire gripper, and the lower wire gripper to make an electrical connection therebetween.

It is an object of the disclosure herein to provide an easy way to make an electrical connect between wires.

It is an object of the disclosure herein to provide an electrical connector for one or more wire to one or more wires.

It is an object of the disclosure herein to provide an electrical connector for one wire to one or more wires.

It is an object of the disclosure herein to provide a stacked 3×3 electric wire connector.

It is an object of the disclosure herein to provide a stacked 1×1 electric wire connector.

It is an object of the disclosure herein to provide a stacked 1×2 electric wire connector.

It is an object of the disclosure herein to provide a stacked 1×3 electric wire connector.

It is an object of the disclosure herein to provide a stacked 1×N electric wire connector.

It is an object of the disclosure herein to provide a stacked N×N electric wire connector.

A feature of the present disclosure includes providing a stacked housing or casing configuration.

A feature of the present disclosure includes a lever connected to a cam to widen or separate a sprung steel C-shape or U-shape wire gripper to enable removeable wire end insertion and gripping therein.

A feature of the present disclosure includes a u-shaped bus to electrically connect one upper and one lower wire gripper in a stack to make an electrical connection between two wires.

A feature of the present disclosure includes a u-shaped bus to electrically connect one upper and two or more lower wire gripper in a stack to make an electrical connection between one wire and multiple wires as a splitter.

These and other features of the electrical wire connector and methods of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The present disclosure for an electrical wire connector and methods of use will be better understood by reading the Detailed Description of the Preferred and Selected Alternate Embodiments with reference to the accompanying drawing Figures, in which like reference numerals denote similar structure and refer to like elements throughout, and in which:

FIG. 1 is a perspective left (lower entry) view of an exemplary embodiment of a housing of an electrical wire connector according, to select embodiments of the disclosure;

FIG. 2 is a perspective right (upper entry) view of an exemplary embodiment of a housing of an electrical wire connector, according to select embodiments of the disclosure;

FIG. 3 is a perspective left (lower entry) view of an exemplary embodiment of the internal components of an electrical wire connector, according to select embodiments of the disclosure;

FIG. 4 is a side view of an exemplary embodiment of the internal components of an electrical wire connector showing a closed lever on the lower and an open lever on the top, according to select embodiments of the disclosure in FIG. 3;

FIG. 5 is a perspective view of an exemplary embodiment of an electrical wire connector showing closed upper and lower levers with three wires gripped in the upper and three wires gripped in the lower level, according to select embodiments of the disclosure in FIG. 3;

FIG. 6A is a perspective left (lower entry) view of an exemplary embodiment of the internal components of an electrical wire connector 1:2 splitter, according to select embodiments of the disclosure;

FIG. 6B is a perspective view of an exemplary embodiment of an electrical wire connector showing closed upper and lower levers with two wires gripped in the upper and one wire gripped in the lower level, according to select embodiments of the disclosure in FIG. 6A;

FIG. 7A is a perspective left (lower entry) view of an exemplary embodiment of the internal components of an electrical wire connector 1:3 splitter, according to select embodiments of the disclosure; and

FIG. 7B is a perspective view of an exemplary embodiment of an electrical wire connector showing closed upper and lower levers with three wires gripped in the upper and one wire gripped in the lower level, according to select embodiments of the disclosure in FIG. 7A.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in the figures, specific terminology is employed for clarity. The present disclosure, however, is not intended to be limited to the specific terminology selected; it is to be understood that each specific element includes all technical equivalents that operate in a similar manner to accomplish similar functions. Embodiments of the claims may, however, be embodied in many different forms and should not be construed as limited to the embodiments set forth herein. The examples set forth herein are non-limiting examples, and are merely examples among other possible examples. It is recognized herein that the optimum dimensional relationships, to include variations in size, materials, shape, form, position, connection, function and manner of operation, assembly and use, are intended to be encompassed by the present disclosure.

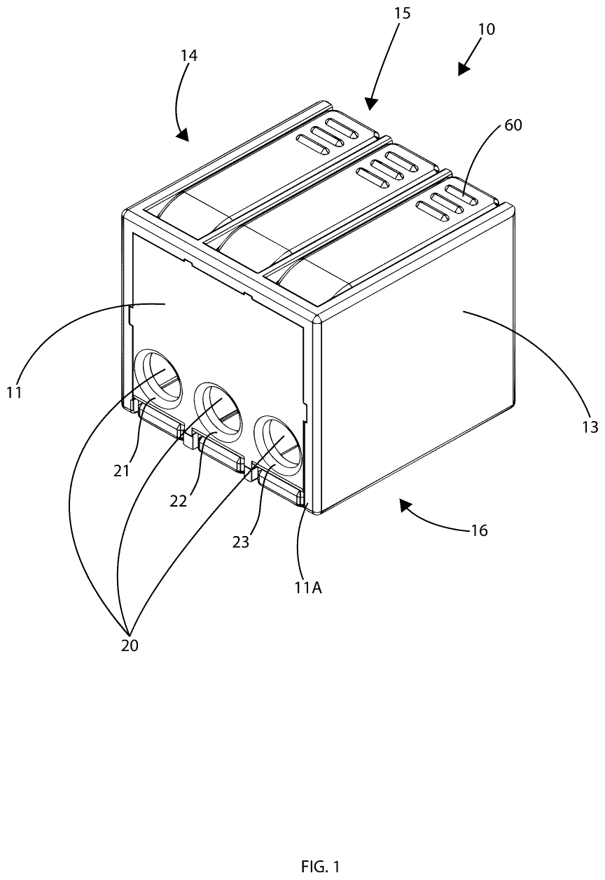

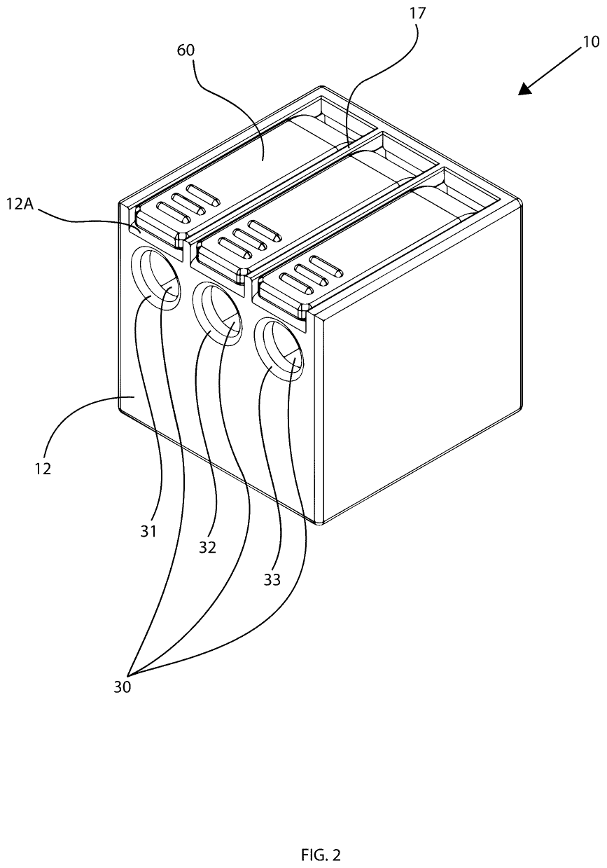

Referring now to FIGS. 1 and 2, by way of example, and not limitation, there is illustrated an example embodiment of an apparatus to electrically connect conductors or wires W, multi-wire connector apparatus, such as electrical wire connector 10 surrounded by or having an insulated shell, cover, or casing, such as insulated housing configured of sides such as left entry side 11, right entry side 12, front side 13, backside 14, top upper lever side 15, and bottom lower lever side 16.

Many components herein other than electrical connections, such as vertical insulative dividers 80, lever and cam 40, 60, and housing of electrical wire connector 10 may be configured of sides such as left entry side 11, right entry side 12, front side 13, backside 14, top upper lever side 15, and bottom lower lever side 16, which are preferably formed of a suitable material, such as plastic, rubber, or the like, capable of providing structure to electrical wire connector 10. Preferably, the material includes other suitable characteristics, such as electrical resistance, non-conductivity, durability, water-resistance, light weight, heat-resistance, chemical inertness, oxidation resistance, ease of workability, or other beneficial characteristic understood by one skilled in the art.

Top upper lever side 15 and bottom lower lever side 16 may include one or more insulated partition(s), such as insulative dividers 80 to electrically separate top upper lever side 15 and bottom lower lever side 16 into an isolated electrical compartments.

Left entry side 11 may include one or more holes therethrough, such as aperture 20. Apertures 20 may be configured to provide entry of conductors or wires W therethrough left entry side 11 to enable conductors or wires W to access and connect therein electrical wire connector 10. In this preferred embodiment for a ROMEX or set of three conductors or wires W connection inside left entry side 11 includes one or more apertures, such as three apertures 21, 22, and 23 aligned linearly in a row (linear row) proximate lower edge 11A of left entry side 11 to accommodate a first ROMEX or set of three conductors or wires W, or to receive the plurality of wire ends BW.

Right entry side 12 may include one or more holes therethrough, such as aperture 30. Apertures 30 may be configured to provide entry of conductors or wires W therethrough right entry side 12 to enable conductors or wires W to access and connect therein electrical wire connector 10. In this preferred embodiment for a second ROMEX or second set of three conductors or wires W connection inside right entry side 12 includes one or more apertures, such as three apertures 31, 32, and 33 aligned linearly in a row (linear row) proximate upper edge 12A of right entry side 12 to accommodate a second ROMEX or second set of three conductors or wires W or to receive the plurality of wire ends BW.

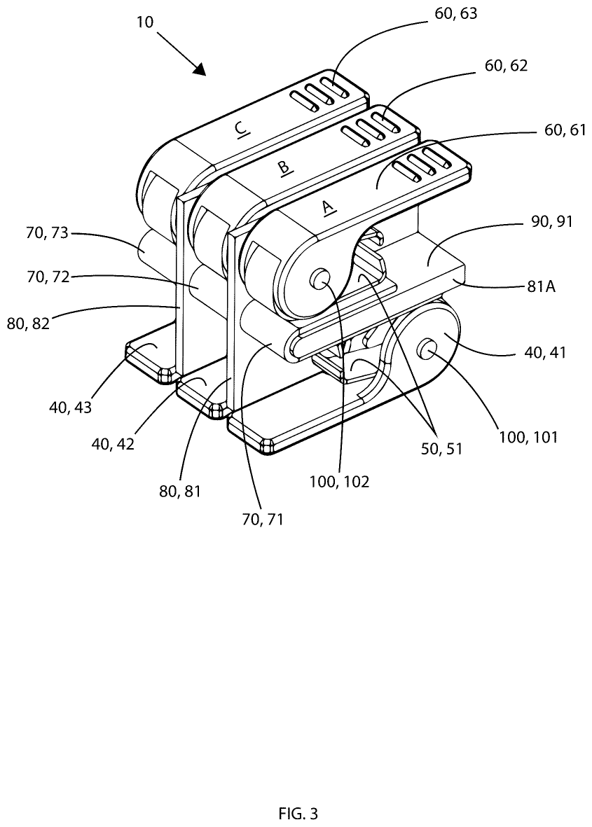

Referring now to FIG. 3, by way of example, and not limitation, there is illustrated an example embodiment of an apparatus to electrically connect conductors or wires W, such as electrical wire connector 10 and its internal components. In this embodiment of electrical wire connector 10 shown in FIG. 3, preferably for electrically connecting two ends of different ROMEX or sets of three conductors or wires W end to end. Electrical wire connector 10, one or more stacked connector modules position side-by-side, preferably include three sets of stacked electrical connectors A, B, C and separated by two vertical electrical isolation dividers, such as vertical insulative dividers 80, and more specifically first insulative divider 81 and second insulative dividers 82 to create isolated stacked switching compartments. Each stacked electrical connector (A, B, C) unit is preferably configured to connect one conductor or wire W from each set of two end of different ROMEX or sets of three conductors or wires W end to end.

Stacked electrical connector A preferably includes lower lever, such as first lower lever and cam 40, 41 (cam shown as 45) which is preferably pivotably and rotatable or utilized to rotationally mount about pin 100, 101 affixed to first vertical insulative divider 80, 81 to enable rotation R between an open lever position and a closed lever position. Rotation R to an open or approximately ninety degrees of rotation of first lower lever and cam 40, 41 expands lower wire gripper, such as sprung wire gripper 50, 51 (wire release position) to enable insertion therein of one of a ROMEX or the set of three conductors or wires W. Return rotation R to closed or approximately ninety degrees of rotation of first lower lever and cam 40, 41 enable contraction of sprung wire gripper 50, 51 (wire grip position) to enable grip(ping) therein of one of a ROMEX or the set of three conductors or wires W.

Stacked electrical connector A preferably includes upper lever, such as first upper lever and cam 60, 61 (cam shown as 65) which is preferably pivotably and rotatable or utilized to rotationally mount about pin 100, 102 affixed to first insulative divider 80, 81 to enable rotation R between an open lever position and a closed lever position. Rotation R to an open or approximately ninety degrees of rotation of first upper lever and cam 60, 61 expands upper wire gripper, such as sprung wire gripper 50, 52 (wire release position) to enable insertion therein of another of a ROMEX or the set of three conductors or wires W. Return rotation R to closed or approximately ninety degrees of rotation of first upper lever and cam 60, 61 enable contraction of sprung wire gripper 50, 52 (wire grip position) to enable grip(ping) therein of another of a ROMEX or the set of three conductors or wires W.

Positioned between first upper lever and cam 60, 61 sprung wire gripper 50, 52 and first lower lever and cam 40, 41 sprung wire gripper 50, 51 is preferably conductor 70, 71 to make an electrical connection therebetween. Conductor 70, 71 is preferably in contact on one end thereto first upper lever and cam 60, 61 sprung wire gripper 50, 52 and on the other end to first lower lever and cam 40, 41 sprung wire gripper 50, 51 to form an electrical connection therebetween. In this embodiment, conductor 70, 71 is preferably configured as U-shaped and held in place by a perpendicular protrusion therefrom first vertical insulative divider 80, 81, such as shelf 81A to support conductor 70, 71 therebetween first upper lever and cam 60, 61 sprung wire gripper 50, 52 and first lower lever and cam 40, 41 sprung wire gripper 50, 51.

Stacked electrical connector B preferably includes second lower lever and cam 40, 42 which is preferably pivotably and rotatable or utilized to rotationally mount about pin 100, 101 affixed to first and second vertical insulative divider 80, 81, 82 to enable rotation R between an open lever position and a closed lever position. Rotation R to an open or approximately ninety degrees of rotation of second lower lever and cam 40, 42 expands sprung wire gripper 50, 51 to enable insertion therein of one of a ROMEX or the set of three conductors or wires W. Return rotation R to closed or approximately ninety degrees of rotation of second lower lever and cam 40, 42 enable contraction of sprung wire gripper 50, 51 to enable grip(ping) therein of one of a ROMEX or the set of three conductors or wires W.

Stacked electrical connector B preferably includes second upper lever and cam 60, 62 which is preferably pivotably and rotatable or utilized to rotationally mount about pin 100, 102 affixed to first and second vertical insulative divider 80, 81, 82 to enable rotation R between an open lever position and a closed lever position. Rotation R to an open or approximately ninety degrees of rotation of second upper lever and cam 60, 62 expands sprung wire gripper 50, 52 to enable insertion therein of another of a ROMEX or the set of three conductors or wires W. Return rotation R to close or approximately ninety degrees of rotation of second upper lever and cam 60, 62 enables contraction of sprung wire gripper 50, 52 to enable grip (ping) therein of another of a ROMEX or the set of three conductors or wires W.

Positioned between second upper lever and cam 60, 62 sprung wire gripper 50, 52 and second lower lever and cam 40, 42 sprung wire gripper 50, 51 is preferably conductor 70, 72. Conductor 70, 72 is preferably in contact on one end thereto second upper lever and cam 60, 62 sprung wire gripper 50, 52 and on the other end to second lower lever and cam 40, 42 sprung wire gripper 50, 51 to form an electrical connection therebetween. In this embodiment, conductor 70, 72 is preferably configured as U-shaped and held in place by a perpendicular protrusion therefrom first and second vertical insulative divider 80, 81, 82 such as shelf 81A to support conductor 70, 72 therebetween second upper lever and cam 60, 62 sprung wire gripper 50, 52 and second lower lever and cam 40, 42 sprung wire gripper 50, 51.

Stacked electrical connector C preferably includes second lower lever and cam 40, 43 which is preferably pivotably and rotatable or utilized to rotationally mount about pin 100, 101 affixed to second vertical insulative divider 80, 82 to enable rotation R between an open lever position and a closed lever position. Rotation R to an open or approximately ninety degrees of rotation of third lower lever and cam 40, 43 expands sprung wire gripper 50, 51 to enable insertion therein of one of a ROMEX or the set of three conductors or wires W. Return rotation R to closed or approximately ninety degrees of rotation of third lower lever and cam 40, 43 enable contraction of sprung wire gripper 50, 51 to enable grip(ping) therein of one of a ROMEX or the set of three conductors or wires W.

Stacked electrical connector C preferably includes third upper lever and cam 60, 63 which is preferably pivotably and rotatable or utilized to rotationally mount about pin 100, 102 affixed to second vertical insulative divider 80, 82 to enable rotation R between an open lever position and a closed lever position. Rotation R to an open or approximately ninety degrees of rotation of third upper lever and cam 60, 63 expands sprung wire gripper 50, 52 to enable insertion therein of another of a ROMEX or the set of three conductors or wires W. Return rotation R to close or approximately ninety degrees of rotation of third upper lever and cam 60, 63 enables contraction of sprung wire gripper 50, 52 to enable grip (ping) therein of another of a ROMEX or the set of three conductors or wires W.

Positioned between third upper lever and cam 60, 63 sprung wire gripper 50, 52 and third lower lever and cam 40, 43 sprung wire gripper 50, 51 is preferably conductor 70, 73. Conductor 70, 73 is preferably in contact on one end thereto third upper lever and cam 60, 63 sprung wire gripper 50, 52 and on the other end to third lower lever and cam 40, 43 sprung wire gripper 50, 51 to form an electrical connection therebetween. In this embodiment, conductor 70, 73 is preferably configured as U-shaped and held in place by a perpendicular protrusion therefrom second vertical insulative divider 80, 82 such as shelf 81A to support conductor 70, 73 therebetween third upper lever and cam 60, 63 sprung wire gripper 50, 52 and third lower lever and cam 40, 43 sprung wire gripper 50, 51.

Many components herein such as electrical connections, such as sprung wire gripper 50 and conductor 70 may be configured of high strength spring steel or other like conductive materials, capable of providing structure to sprung wire gripper 50. Preferably, the material includes other suitable characteristics, such as electrical conductivity (tin plated copper), repeatable open and close gripping strength, or naturally compressed and uncompressed states to allow open insertion of one of a ROMEX or the set of three conductors or wires W and grip (ping) therein ease of workability, or other beneficial characteristic understood by one skilled in the art.

It is contemplated herein that electrical wire connector 10 may be configured as an NxN connector.

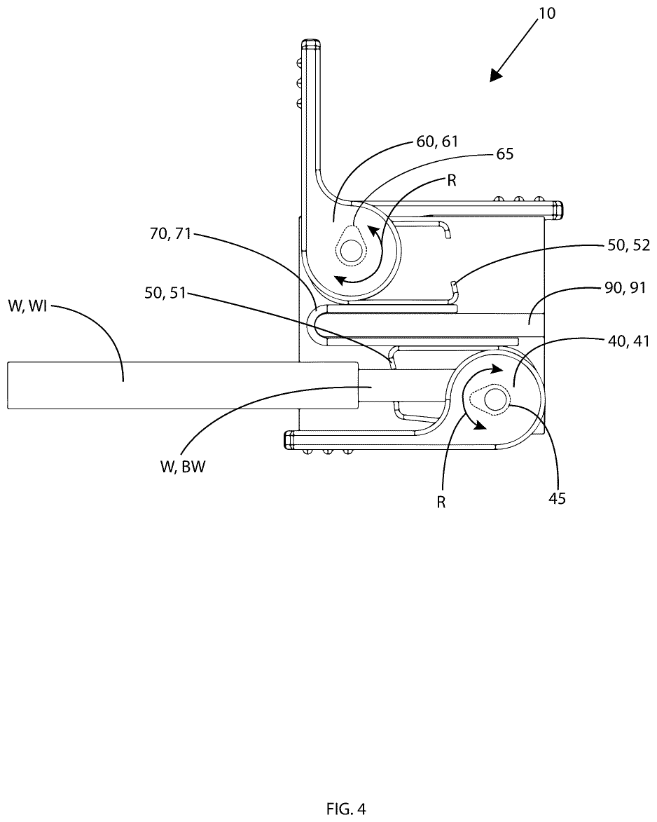

Referring now to FIG. 4, by way of example, and not limitation, there is illustrated an example embodiment of an apparatus to electrically connect conductors or wires W, such as electrical wire connector 10 showing a closed lever on the lower and an open lever on the top according to select embodiments of the disclosure in FIG. 3. In this embodiment of electrical wire connector 10 shown in FIG. 4, preferably for electrically connecting two end of different ROMEX or sets of three conductors or wires W end to end.

Stacked electrical connector A preferably includes first lower lever and cam 40, 41 which is preferably pivotably and rotatable about pin 100, 101 affixed to first vertical insulative divider 80, 81 to enable rotation R between an open lever position and a closed lever position. Operable rotation R to closed or approximately ninety degrees of rotation R of first lower lever and cam 40, 41 to abut bottom lower lever side 16 to enable contraction of sprung wire gripper 50, 51 to enable grip(ping) therein of one of a ROMEX or the set or plurality of three conductors or wires W (shown with bare BW (plurality of wire ends) of wire W inserted and gripped therein sprung wire gripper 50, 51).

Stacked electrical connector A preferably includes first upper lever and cam 60, 61 which is preferably pivotably and rotatable about pin 100, 102 affixed to first insulative divider 81 to enable rotation R between an open lever position and a closed lever position. Operable rotation R to an open or approximately ninety degrees of rotation R from top upper lever side 15 of first upper lever and cam 60, 61 expands sprung wire gripper 50, 52 to ready for insertion therein of another of a ROMEX or the set or plurality of three conductors or wires W (such as bare BW (plurality of wire ends) (plurality of wire ends) of wire W).

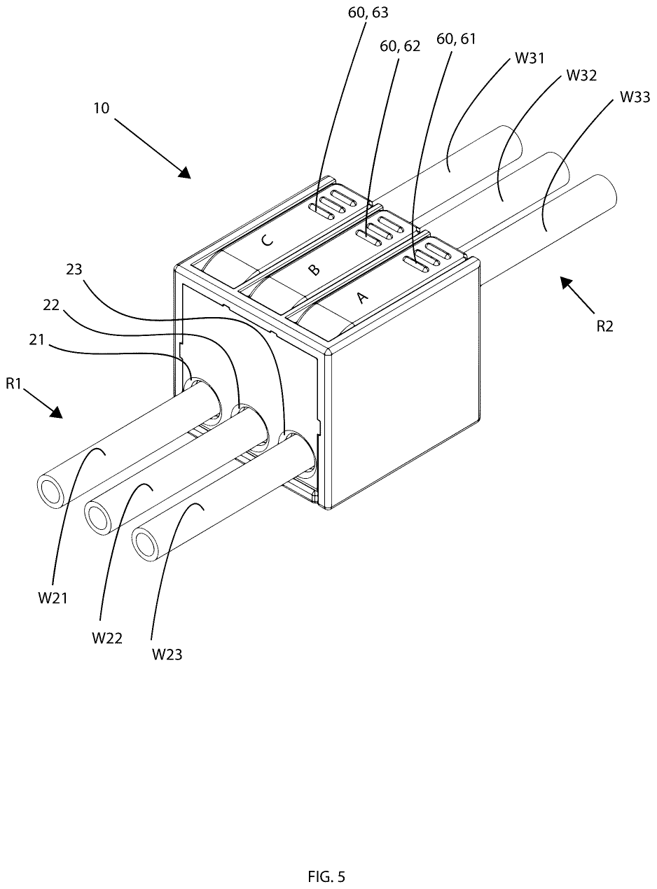

Referring now to FIG. 5, by way of example, and not limitation, there is illustrated an example embodiment of an apparatus to electrically connect conductors or wires W, such as electrical wire connector 10, show in use. In this embodiment of electrical wire connector 10 shown in FIG. 5, preferably for electrically connecting two ends of different ROMEX or sets of three conductors or wires W end to end. Electrical wire connector 10 preferably include three sets of stacked electrical connectors A, B, C and separated by two vertical electrical isolation dividers, such as vertical insulative dividers 80 (shown in FIG. 3). Each stacked electrical connector (A, B, C) unit is preferably configured to connect one conductor or wire W from each set of two ends of different ROMEX or sets of three conductors or wires W end to end. For example, plurality of wire ends, such as first ROMEX R1 or first set of three conductors or wires W, such as wires W21, W22, W23 are inserted therethrough three apertures 21, 22, and 23, respectively. Likewise, another plurality of wire ends, such as second ROMEX R2 or second set of three conductors or wires W, such as wires W31, W32, W33 are inserted therethrough three apertures 31, 32, and 33 (shown in FIG. 2), respectively. In this embodiment, each stacked electrical connector (A, B, C) unit is preferably configured to electrically connect one wire end to the other stacked there above, such as wire W21 is preferably electrically connected to wire W31, wire W22 is preferably electrically connected to wire W32, wire W23 is preferably connected to wire W33.

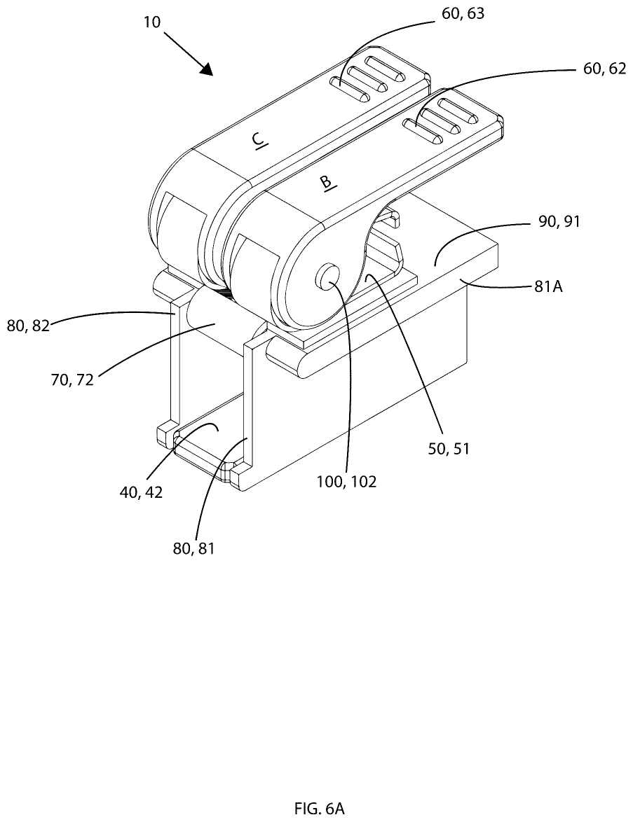

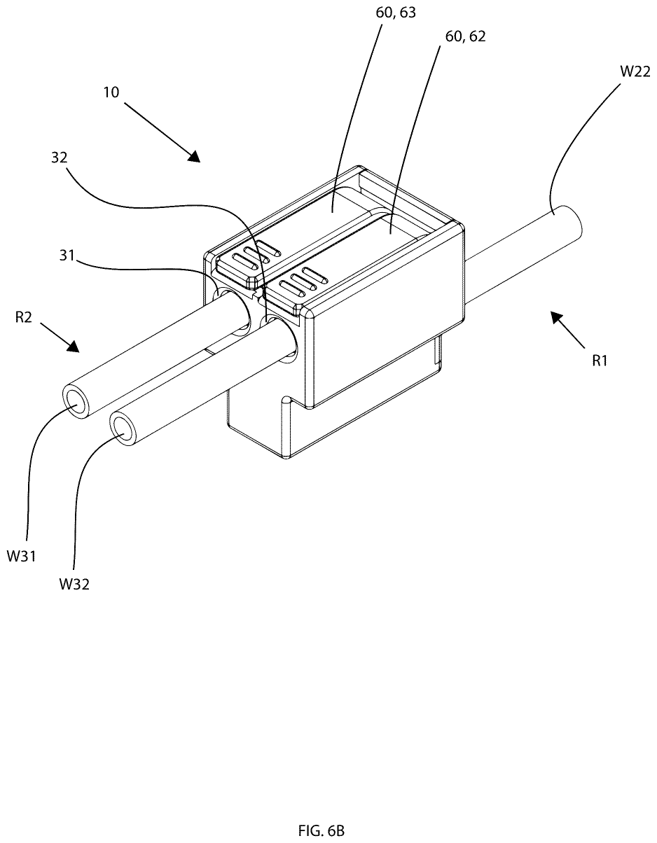

Referring now to FIG. 6A, by way of example, and not limitation, there is illustrated an example embodiment of an apparatus to electrically connect conductors or wires W, such as electrical wire connector 10 configured as a 1:2 multi-wire splitter apparatus having one stacked connector module and its internal components. In this embodiment of electrical wire connector 10 shown in FIG. 6A, preferably for electrically connecting three ends of different conductors or wires W end to end. Electrical wire connector 10 preferably includes 1:2 set of stacked electrical connectors B and C without vertical electrical isolation dividers, such as vertical insulative dividers 80 (shown in FIG. 3).

Stacked electrical connector A preferably includes first lower lever and cam 40, 42 which is preferably pivotably and rotatable about pin 100, 102 affixed to first vertical support 80, 81 and second vertical support 80, 82 to enable rotation R between an open lever position and a closed lever position. Rotation R to an open or approximately ninety degrees of rotation of first lower lever and cam 40, 42 expands first lower wire gripper, such as sprung wire gripper 50, 51 to enable insertion therein of one conductor or wire W. Return rotation R to closed or approximately ninety degrees of rotation of first lower lever and cam 40, 42 enable contraction of sprung wire gripper 50, 51 to enable grip(ping) therein of one conductor or wire W.

Stacked electrical connector B preferably includes first upper lever and cam 60, 62 which is preferably pivotably and rotatable about pin 100, 102 affixed to first vertical support 80, 81 and second vertical support 80, 82 to enable rotation R between an open lever position and a closed lever position. Rotation R to an open or approximately ninety degrees of rotation of first upper lever and cam 60, 62 expands first upper wire gripper, such as sprung wire gripper 50, 51 to enable insertion therein of second conductor or wire W. Return rotation R to closed or approximately ninety degrees of rotation of first upper lever and cam 60, 62 enable contraction of sprung wire gripper 50, 51 to enable grip (ping) therein of second conductor or wire W.

Stacked electrical connector C preferably includes second upper lever and cam 60, 63 which is preferably pivotably and rotatable about pin 100, 102 affixed to first and second vertical support 80, 81, 82 to enable rotation R between an open lever position and a closed lever position. Rotation R to an open or approximately ninety degrees of rotation of second upper lever and cam 60, 63 expands second upper wire gripper, such as sprung wire gripper 50, 52 to enable insertion therein of third conductor or wire W. Return rotation R to closed or approximately ninety degrees of rotation of second upper lever and cam 60, 63 enable contraction of sprung wire gripper 50, 52 to enable grip(ping) therein of third conductor or wire W.

Positioned between first upper lever and cam 60, 62 sprung wire gripper 50, 51, second upper lever and cam 60, 63 sprung wire gripper 50, 52, and first lower lever and cam 40, 42 sprung wire gripper 50, 51 is preferably conductor 70, 72. Conductor 70, 72 is preferably in contact on one end thereto first upper lever and cam 60, 62 sprung wire gripper 50, 51 and second upper lever and cam 60, 63 sprung wire gripper 50, 52, and on the other end to first lower lever and cam 40, 42 sprung wire gripper 50, 51 to form an electrical connection therebetween (1:2 splitter). In this embodiment, conductor 70, 72 is preferably configured as U-shaped and held in place by first and second vertical support 80, 81, 82 such as shelf 81A to support conductor 70, 72 therebetween first upper lever and cam 60, 62 sprung wire gripper 50, 51, second upper lever and cam 60, 63 sprung wire gripper 50, 51, and first lower lever and cam 40, 42 sprung wire gripper 50, 52.

Referring now to FIG. 6B, by way of example, and not limitation, there is illustrated an example embodiment of an apparatus to electrically connect conductors or wires W, such as electrical wire connector 10, show in use. In this embodiment of electrical wire connector 10 shown in FIG. 6A, preferably for electrically connecting three ends of three conductors or wires W end to end (1:2 splitter). Electrical wire connector 10 preferably include one set of stacked electrical connectors A and an upper B. Each stacked electrical A unit is preferably configured to connect one conductor or wire W to another two wires W end to end. For example, first conductor or wire W, such as wire W22 is inserted therethrough aperture 22. Likewise, second and third wires W, such as wires W31, W32 are inserted therethrough two apertures 31, and 32 (shown in FIG. 2), respectively. In this embodiment, stacked electrical connector A unit is preferably configured to electrically connect one wire end to the other two stacked there above, one wire end BW, such as wire W22 is preferably electrically connected to two wire ends BW, such as wire W31 and W32, as a 1:2 splitter.

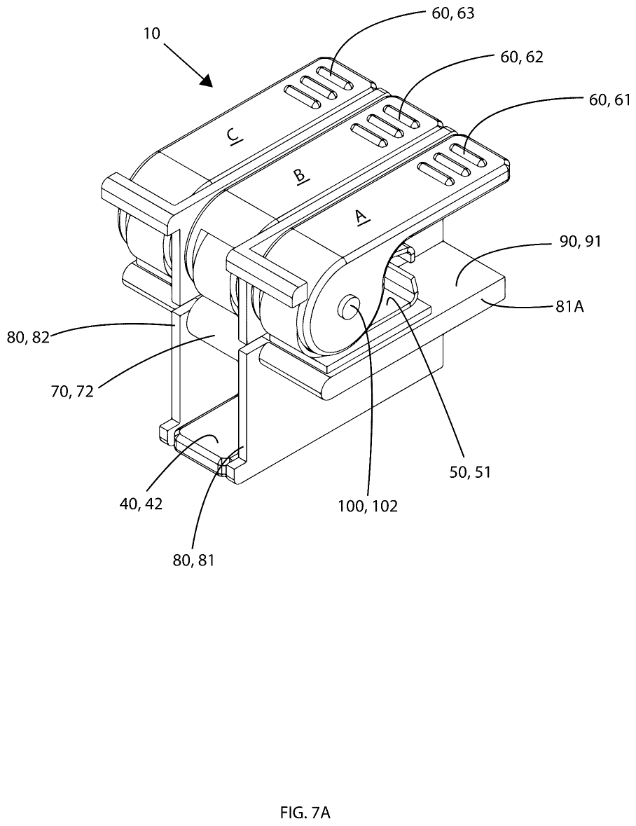

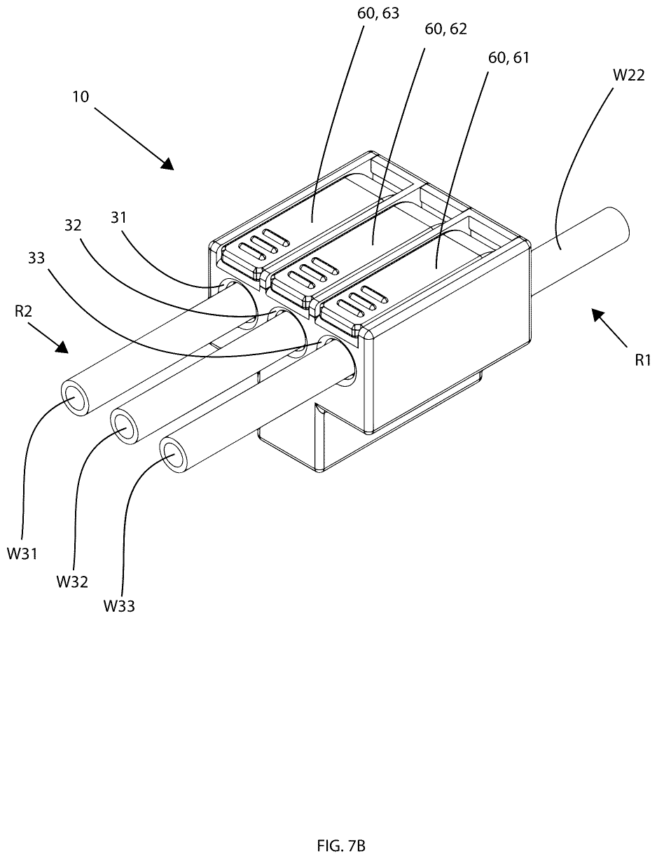

Referring now to FIG. 7A, by way of example, and not limitation, there is illustrated an example embodiment of an apparatus to electrically connect conductors or wires W, such as electrical wire connector 10 configured as a 1:3 splitter having one stacked connector module and its internal components. In this embodiment of electrical wire connector 10 shown in FIG. 7A, preferably for electrically connecting four ends of different conductors or wires W end to end. Electrical wire connector 10 preferably includes 1:3 set of stacked electrical connectors A, B, C without vertical electrical isolation dividers, such as vertical support 80 (shown in FIG. 3).

Stacked electrical connector A preferably includes first lower lever and cam 40, 42 which is preferably pivotably and rotatable about pin 100, 101 affixed to first and second vertical support 80, 81, 82 to enable rotation R between an open lever position and a closed lever position. Rotation R to an open or approximately ninety degrees of rotation of first lower lever and cam 40, 42 expands first lower wire gripper, such as sprung wire gripper 50, 51 to enable insertion therein of one conductor or wire W. Return rotation R to closed or approximately ninety degrees of rotation of first lower lever and cam 40, 42 enable contraction of sprung wire gripper 50, 51 to enable grip(ping) therein of one conductor or wire W.

Stacked electrical connector A preferably includes first upper lever and cam 60, 61 which is preferably pivotably and rotatable about pin 100, 102 affixed to first vertical support 80, 81 to enable rotation R between an open lever position and a closed lever position. Rotation R to an open or approximately ninety degrees of rotation of first upper lever and cam 60, 61 expands first upper wire gripper, such as sprung wire gripper 50, 51 to enable insertion therein of second conductor or wire W. Return rotation R to closed or approximately ninety degrees of rotation of first upper lever and cam 60, 61 enable contraction of sprung wire gripper 50, 51 to enable grip(ping) therein of second conductor or wire W.

Stacked electrical connector B preferably includes second upper lever and cam 60, 62 which is preferably pivotably and rotatable about pin 100, 102 affixed to first and second vertical support 80, 81, 82 to enable rotation R between an open lever position and a closed lever position. Rotation R to an open or approximately ninety degrees of rotation of third upper lever and cam 60, 63 expands second upper wire gripper, such as sprung wire gripper 50, 52 to enable insertion therein of fourth conductor or wire W. Return rotation R to closed or approximately ninety degrees of rotation of third upper lever and cam 60, 63 enable contraction of sprung wire gripper 50, 52 to enable grip(ping) therein of fourth conductor or wire W.

Stacked electrical connector C preferably includes third upper lever and cam 60, 63 which is preferably pivotably and rotatable about pin 100, 102 affixed to second vertical support 80, 82 to enable rotation R between an open lever position and a closed lever position. Rotation R to an open or approximately ninety degrees of rotation of third upper lever and cam 60, 63 expands third upper wire gripper, such as sprung wire gripper 50, 53 to enable insertion therein of fourth conductor or wire W. Return rotation R to closed or approximately ninety degrees of rotation of third upper lever and cam 60, 63 enable contraction of sprung wire gripper 50, 53 to enable grip(ping) therein of fourth conductor or wire W.

Positioned between first upper lever and cam 60, 61 sprung wire gripper 50, 52, second upper lever and cam 60, 62 sprung wire gripper 50, 52, third upper lever and cam 60, 63 third upper wire gripper, such as sprung wire gripper 50, 53, and first lower lever and cam 40, 42 sprung wire gripper 50, 51 is preferably conductor 70, 72. Conductor 70, 72 is preferably in contact on one end thereto first upper lever and cam 60, 61 sprung wire gripper 50, 51, second upper lever and cam 60, 62 sprung wire gripper 50, 52, and third upper lever and cam 60, 63 sprung wire gripper 50, 53, and on the other end to first lower lever and cam 40, 42 sprung wire gripper 50, 51 to form an electrical connection therebetween (1:3 splitter). In this embodiment, conductor 70, 72 is preferably configured as U-shaped and held in place by first and second vertical support 80, 81, 82 such as shelf 81A, to support conductor 70, 72 therebetween first upper lever and cam 60, 61 sprung wire gripper 50, 51, second upper lever and cam 60, 62 sprung wire gripper 50, 52, third upper lever and cam 60, 63 sprung wire gripper 50, 53, and first lower lever and cam 40, 42 sprung wire gripper 50, 51.

Referring now to FIG. 7B, by way of example, and not limitation, there is illustrated an example embodiment of an apparatus to electrically connect conductors or wires W, such as electrical wire connector 10, show in use. In this embodiment of electrical wire connector 10 shown in FIG. 7A, preferably for electrically connecting four ends of four conductors or wires W end to end (1:3 multi-wire splitter apparatus). Electrical wire connector 10 preferably include one set of stacked electrical connectors A and an upper B and C. Each stacked electrical A unit is preferably configured to connect one conductor or wire W to another three wires W end to end. For example, first conductor or one wire W, such as wire W22 is inserted therethrough aperture 22. Likewise, another three wires W, such as second, third and fourth wires W, such as wires W31, W32, W33 are inserted therethrough three apertures 31, 32, and 33 (shown in FIG. 2), respectively. In this embodiment, stacked electrical connector A unit is preferably configured to electrically connect one wire end to the other two stacked there above, such as wire W22 is preferably electrically connected to wire W31, W32 and W33, as a 1:3 splitter.

It is contemplated herein that electrical wire connector 10, shown in FIGS. 3-7, may be expandable to 1:4, 1:5 . . . 1:N splitter.

Concerning the description herein, it is to be realized that the optimum dimensional relationships, including variations in size, materials, shape, form, configuration, position, connection, function and manner of operation, assembly and use, are intended to be encompassed by the present disclosure.

It is further understood herein that the parts and elements of this disclosure may be located or positioned elsewhere based on one of ordinary skill in the art without deviating from the present disclosure.

With respect to the above description, it is to be realized that the optimum dimensional relationships, including variations in size, materials, shape, form, position, movement mechanisms, function and manner of operation, assembly and use, are intended to be encompassed by the present disclosure.

The foregoing description and drawings comprise illustrative embodiments. Regarding the described exemplary embodiments, it should be noted by those skilled in the art that the disclosures within are exemplary only, and that various other alternatives, adaptations, and modifications may be made within the scope of the present disclosure. Merely listing or numbering the steps of a method in a particular order does not constitute any limitation on the order of the steps of that method. Many modifications and other embodiments will come to mind for one skilled in the art this disclosure pertains to, having the benefit of the teachings presented in the foregoing descriptions and the associated drawings. Although specific terms may be employed herein, they are used in a generic and descriptive sense only and not for purposes of limitation. Moreover, the present disclosure has been described in detail; it should be understood that various changes, substitutions and alterations can be made thereto without departing from the spirit and scope of the disclosure as defined by the appended claims. Accordingly, the present disclosure is not limited to the specific embodiments illustrated herein but is limited only by the following claims.

1. A multi-wire connector apparatus to electrically connect a plurality of wire ends to another plurality of wire ends, said apparatus comprising:
one or more stacked connector modules position side-by-side, each module having an upper lever having a cam connected thereto and rotationally operable with an upper wire gripper, said upper wire gripper rotatable between a wire release position and a wire grip position, a lower lever having a cam connected thereto and rotationally operable with a lower wire gripper, said lower wire gripper rotatable between a wire release position and a wire grip position; and
a conductor positioned between said upper wire gripper and said lower wire gripper to make an electrical connection therebetween.

2. The apparatus of claim 1, wherein said conductor is u-shaped.

3. The apparatus of claim 1, wherein said one or more stacked connector modules position side-by-side is three.

4. The apparatus of claim 1, wherein said one or more stacked connector modules position side-by-side is two.

5. The apparatus of claim 1, wherein said one or more stacked connector modules is configured with an insulated partition therebetween to electrically separate said upper wire gripper and lower wire gripper into an isolated switching compartment.

6. The apparatus of claim 2, wherein each of said one or more stacked connector modules is separated by a vertical insulative divider to electrically separate said one or more stacked connector modules and utilized to rotationally mount said upper lever and said lower lever.

7. The apparatus of claim 1, wherein said one or more stacked connector modules is surrounded by an insulated housing having a left entry side and a right entry side, each said left entry side and a right entry side configured having one or more apertures therein a linear row to receive the plurality of wire ends and the another plurality of wire ends.

8. The apparatus of claim 6, wherein said vertical insulative divider is configured with a perpendicular protrusion therefrom to support said conductor.

9. A multi-wire splitter apparatus to electrically connect one wire end to another two wire ends, said apparatus comprising:
one stacked connector module, having a first upper lever having a cam connected thereto and rotationally operable with a first upper wire gripper, said first upper wire gripper rotatable between a wire release position and a wire grip position, a lower lever having a cam connected thereto and rotationally operable with a lower wire gripper, said lower wire gripper rotatable between a wire release position and a wire grip position;
a second upper lever having a cam connected thereto and rotationally operable with a second upper wire gripper, said second upper wire gripper rotatable between a wire release position and a wire grip position; and
a conductor positioned between said first upper wire gripper, said second upper wire gripper, and said lower wire gripper to make an electrical connection therebetween.

10. The apparatus of claim 9, wherein said conductor is u-shaped.

11. The apparatus of claim 9, wherein said one stacked connector module and said second upper wire gripper having a vertical support utilized to rotationally mount said first upper lever, said second upper lever, and said lower lever.

12. The apparatus of claim 9, wherein said one stacked connector module and said second upper wire gripper is surrounded by an insulated housing having a left entry side and a right entry side, said left entry side configured having one aperture and said right entry side configured having two apertures therein a linear row to receive the wire end and the another two wire ends.

13. The apparatus of claim 11, wherein said vertical support is configured with a perpendicular protrusion therefrom to support said conductor.

14. A multi-wire splitter apparatus to electrically connect one wire end to another three wire ends, said apparatus comprising:
one stacked connector module, having a first upper lever having a cam connected thereto and rotationally operable with a first upper wire gripper, said first upper wire gripper rotatable between a wire release position and a wire grip position, a lower lever having a cam connected thereto and rotationally operable with a lower wire gripper, said lower wire gripper rotatable between a wire release position and a wire grip position;
a second upper lever having a cam connected thereto and rotationally operable with a second upper wire gripper, said second upper wire gripper rotatable between a wire release position and a wire grip position;
a third upper lever having a cam connected thereto and rotationally operable with a third upper wire gripper, said third upper wire gripper rotatable between a wire release position and a wire grip position; and
a conductor positioned between said first upper wire gripper, said second upper wire gripper, said third upper wire gripper, and said lower wire gripper to make an electrical connection therebetween.

15. The apparatus of claim 14, wherein said conductor is u-shaped.

16. The apparatus of claim 14, wherein said one stacked connector module, said second upper wire gripper having a first vertical support utilized to rotationally mount said first upper lever, said second upper lever, and said lower lever, and said second upper wire gripper and said third upper wire gripper having a second vertical support utilized to rotationally mount said second upper wire gripper and said third upper wire gripper.

17. The apparatus of claim 14, wherein said one stacked connector module, said second upper wire gripper, and said third upper wire gripper is surrounded by an insulated housing having a left entry side and a right entry side, said left entry side configured having one aperture and said right entry side configured having three apertures therein a linear row to receive the wire end and the another two wire ends.

18. The apparatus of claim 14, wherein said first vertical support is configured with a perpendicular protrusion therefrom to support said conductor.
